(19) United States
(12) Patent Application Publication
(10) Pub. No.: US 2019/0012940 A1
(43) Pub. Date: Jan. 10, 2019

(54) BACK-LIT LIGHTBOX

(71) Applicant: Locomocean Limited, London (GB)

(72) Inventor: Richard Hinton, London (GB)

(21) Appl. No.: 16/028,273

(22) Filed: Jul. 5, 2018

(30) Foreign Application Priority Data
Jul. 4, 2017 (GB) 1710773.01

(51) Int. Cl. G09F 13/04; G09F 15/00

(52) U.S. Cl. CPC G09F 13/0413; G09F 15/0012; G09F 2013/049; G09F 2013/0454; G09F 2013/0445

(57) ABSTRACT

A lightbox includes multiple faces. A front face of the multiple faces is faced in a forward direction. A back face of the multiple faces is face in a backward direction. The lightbox includes one or more light sources. The one or more light sources are disposed within the light box. The one or more light sources are arranged to illuminate the front face. The one or more light sources are arranged to illuminate the back face.

### TECHNICAL FIELD

The present invention relates to a lightbox for providing direct or indirect illumination and/or mood lighting.

### BACKGROUND

A lightbox is a box containing one or more light sources such as a light bulb, LED, or the like, and having at least one surface that is wholly or partially translucent or transparent so that the one or more light sources will illuminate the at least one translucent or transparent surface from within the lightbox, whereby the at least one surface may become more visible in low-light conditions and the lightbox may provide direct and/or ambient lighting to the surrounding area.

Typically only a front face of the lightbox is illuminated to illuminate text or an image displayed thereon.

The present inventor has found it to be desirable to provide illumination also to a back face of the lightbox so as to provide an ambient back-lit effect, or to facilitate displaying different text or images on the front and back surfaces.

### SUMMARY OF THE INVENTION

According to a first aspect of the present invention, there is provided a lightbox having a substantially forward-facing front face and a substantially backward-facing back face and one or more light sources within the lightbox arranged to illuminate the front face and the back face.

In embodiments according to the present invention, the lightbox may be arranged to emit light backwards from the back face to illuminate an area or volume behind the back face.

In any of the foregoing or further embodiments of the lightbox according to the present invention, at least a portion of the front face may be translucent or transparent.

In any of the foregoing or further embodiments of the lightbox according to the present invention, the translucent or transparent portion of the front face may be in the shape of a letter, word, message, image or symbol, and the remainder of the front face be opaque or substantially opaque and preferably may be mirrored to the forward-facing side. In such embodiments, the translucent or transparent portion may be a portion that has been cut out from a sheet that is opaque or substantially opaque and preferably may be mirrored to the forward-facing side. In one embodiment, the front face is mirrored and the translucent or transparent portion of the front face is arranged to be illuminated by the light source and may exhibit the phrase “#SELFIE”.

In any of the foregoing or further embodiments of the lightbox according to the present invention, at least a portion of the back face may be translucent or transparent, and in some embodiments substantially all of the back face may be translucent or transparent.

In any of the foregoing or further embodiments of the lightbox according to the present invention, the front and back faces may be substantially the same shape and size and be arranged so as to be substantially parallel to one another and aligned opposite one another.

In any of the foregoing or further embodiments of the lightbox according to the present invention, the lightbox may comprise a frame and the front and back faces be arranged together with the frame to form a box with the one or more light sources disposed within the box. The one or more light sources may be disposed within the frame or on the inside surface of the frame such that a central space within the frame and between the front and back faces is substantially empty. The inside surface of the frame may be mirrored. The frame may include an inner frame set within an outer frame, the front and back faces being mounted on or adjacent to the front and back, respectively, of the inner frame and recessed backwards and forwards, respectively, within the outer frame.

In any of the foregoing or further embodiments of the lightbox according to the present invention, the one or more light sources may be one or more LED strips. The same one or more light sources may illuminate both the front face and the back face, or alternatively different light sources may illuminate the front face and the back face.

In any of the foregoing or further embodiments of the lightbox according to the present invention, the back face may include a light diffusion or dispersion sheet to more evenly distribute light from the one or more light sources by which it is illuminated.

In any of the foregoing or further embodiments, the lightbox according to the present invention may include a light diffusion or dispersion sheet behind the front face to more evenly distribute light from the one or more light sources by which it is illuminated.

In any of the foregoing or further embodiments of the lightbox according to the present invention, the illuminated front and back faces may emit light of the same colour, or alternatively the illuminated front and back faces may emit light of different colours.

In any of the foregoing or further embodiments of the lightbox according to the present invention, the one or more light sources may be configured to produce one or more lighting effects selected from the following list: change colour; vary in brightness or intensity; flash; and fade in and out.

In any of the foregoing or further embodiments of the lightbox according to the present invention, the lightbox may be configured to communicate with another device.

The lightbox may be configured to communicate directly with another device or to communicate with one or more other devices via a network. The other device may be another lightbox, and the lightbox and the another lightbox may be configured to operate in synchronisation with one another to produce a desired lighting pattern or effect, or to operate under command of a common controller.

The other device may also or alternatively be a music player and the lightbox be configured to illuminate the front and/or back faces in conjunction with music being played on the music player.

Alternatively, the other device may be a remote control, and the remote control may be provided by a software application running on a computer processor such as in a smart phone, tablet or laptop.

In any of the foregoing or further embodiments of the lightbox according to the present invention, the one or more light sources may be powered by an external power source connected to the lightbox by wires or a cable. The external power source may include a battery pack and/or a plug connectable to a commercial or domestic power supply.

Alternatively, the one or more light sources may be powered by an internal power source such as a battery pack integrated into the lightbox.

In any of the foregoing or further embodiments of the lightbox according to the present invention, the front face may be provided on a sheet that is mirrored on its backward-facing side.

In any of the foregoing or further embodiments of the lightbox according to the present invention, the front face may be provided on a sheet that can be inserted into a slot in the top or side of the lightbox to position it in front of the one or more light sources. Alternatively, the front face may be provided on a sheet that can be attached to the front of the lightbox by magnetic or other releasable attachment to position it in front of the one or more light sources. In such embodiments, the lightbox may include a plurality of front face sheets that are interchangeable, the sheets bearing different letters, words, messages, images and/or symbols to be illuminated by the one or more light sources.

In any of the foregoing or further embodiments of the lightbox according to the present invention, the front face may be provided with a wipe-clean surface to permit it to be written on and then for the writing to be wiped off. In related embodiments, the lightbox may further include a pen holder and a non-permanent-ink pen releasably securable in the penholder for writing on the wipe-clean surface.

In any of the foregoing or further embodiments of the lightbox according to the present invention, the front face may include a first letter, word, message, image and/or symbol to be illuminated by the one or more light sources and the back face include a second, different letter, word, message, image and/or symbol, or a different combination thereof, to be illuminated by the one or more light sources.

In any of the foregoing or further embodiments of the lightbox according to the present invention, the front and back faces of the lightbox may be in the shape of a square, rectangle, circle, oval, or heart.

According to a second aspect of the present invention there is provided a method comprising: receiving a user input defining a letter, word, message, image and/or symbol; and making a lightbox according to any preceding claim, wherein the letter, word, message, image and/or symbol is formed as a translucent or transparent portion of the front face to be illuminated by the one or more light sources.

Embodiments of the method may further comprise: receiving a second user input defining a second, different letter, word, message, image and/or symbol, or a different combination thereof; and making a lightbox according to any preceding claim, wherein the second, different letter, word, message, image and/or symbol, or different combination thereof, is formed as a translucent or transparent portion of the back face to be illuminated by the one or more light sources.

### BRIEF DESCRIPTION OF THE DRAWINGS

To enable a better understanding of the present invention, and to show how the same may be carried into effect, reference will now be made, by way of example only, to the accompanying drawings, in which:

FIG. 1 shows a front perspective view of a first illustrated embodiment of a lightbox according to the present invention;

FIG. 2 shows a similar front perspective view of the lightbox of FIG. 1, with the front face sheet partially removed;

FIG. 3 shows a similar front perspective view of the lightbox of FIG. 1, with the front face sheet fully removed;

FIG. 4 shows a similar front perspective view of the outer frame of the lightbox of FIG. 1;

FIG. 5 shows a similar front perspective view of the inner frame of the lightbox of FIG. 1;

FIG. 6 shows a reverse perspective view of the lightbox of FIGS. 1 to 5;

FIG. 7 shows a similar reverse perspective view of the lightbox of FIGS. 1 to 6, with the back face sheet fully removed and the front face sheet partially removed;

FIG. 8 shows a front perspective view of a second illustrated embodiment of a lightbox according to the present invention;

FIG. 9 shows a similar front perspective view of the lightbox of FIG. 8, with the front face sheet fully removed;

FIG. 10 shows a reverse perspective view of the lightbox of FIGS. 8 and 9, with the back face sheet fully removed;

FIG. 11 shows a similar reverse perspective view of the lightbox of FIGS. 8 to 10, with the back face sheet fully removed and the front dispersion/diffusion sheet in place;

FIG. 12 shows a front perspective view of a third illustrated embodiment of a lightbox according to the present invention;

FIG. 13 shows a similar front perspective view of the lightbox of FIG. 12, with the front face sheet fully removed;

FIG. 14 shows a reverse perspective view of the lightbox of FIGS. 12 and 13; and

FIG. 15 shows a similar reverse perspective view of the lightbox of FIGS. 12 to 14, with the back face sheet fully removed.

### DETAILED DESCRIPTION

Embodiments of the present invention will now be described with reference to the accompanying drawings figures. In the following description, reference is made to specific examples. Nevertheless, it will be appreciated that alternative structures, configurations and arrangements may provide equivalent or identical functionality and the present invention is intended to encompass all such variations to the extent that they fall within the scope of the appended claims.

In the following, any stated ranges are intended to include the mentioned end value. The abbreviation LED stands for “light emitting diode”.

Reference in the following to a surface that is mirrored or has a mirrored finish may refer to a smooth reflective metallic surface. Typically a mirrored surface will be silver-metallic in colour, but the surface could equally be gold, rose gold or any other metallic colour.

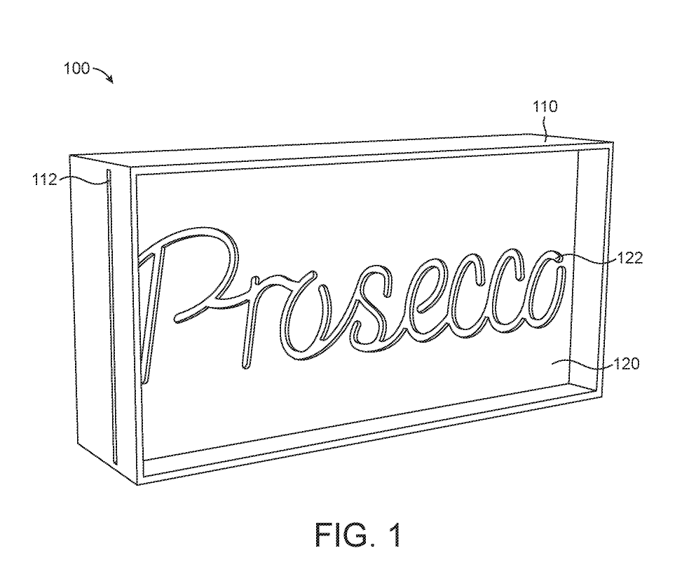

In the following, unless otherwise stated, directional references refer to the orientation shown in FIGS. 1 to 5, 8, 9, 12 and 13, in which the clapperboard is shown in a standing orientation, with the vertical direction of the page substantially aligned with the vertical orientation of the lightbox 100, 200, 300, with upwards being towards the top of the page, the left and right sides being those on the left and right sides of these Figures, and the front or forward face being the major face facing out of the page.

As shown in FIGS. 1 to 7, a first embodiment of a lightbox in accordance with the present invention includes a frame 110. The frame 110 surrounds a front face 120 of the lightbox 100, such that the front face 120 is recessed back from the front of the frame 110.

In this embodiment, the front face 120 is substantially opaque, and is provided with a mirrored finish to the forward-facing front surface. A portion 122 of the front face 120 is translucent or transparent, and in the example of the embodiment of FIG. 1 exhibits the word “Prosecco”. Light within the lightbox 100 illuminates the front face 120, such that light is emitted through the transparent or translucent portion 122, whereby the word “Prosecco” is illuminated.

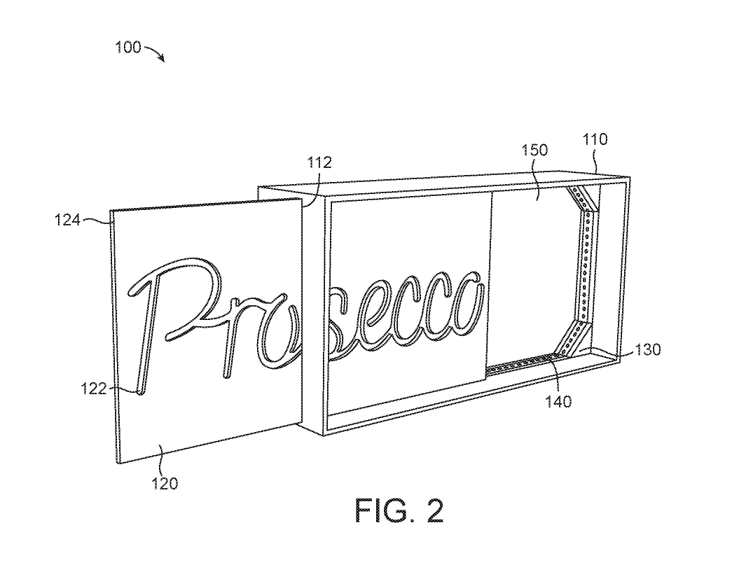

As can be seen with reference to FIG. 2, the front face 120 is provided on a front face sheet 124, which can be slidably removed from the frame 110 via a vertical slot 112 provided on one side of the frame 110. The front face sheet 124 may thereby be made interchangeable, such that different words, letters, symbols, images, messages or other graphics may be displayed in illuminated fashion on the front surface 120 of the lightbox 100.

It will be appreciated that the graphic of the word “Prosecco” or such other words, letters, symbols, messages, or images that are to be illuminated on the front face 120 may be provided in a number of different ways, in order to provide the transparent or translucent illuminated portion 122. In the example of FIGS. 1 to 7 of the present application, the transparent portion 122 is provided as a cut-out in the front face sheet 124, which cut-out is a hole that passes entirely through the sheet 124 so as to allow light from within the lightbox to pass directly through the sheet 124. As one example, laser cutting may be used to form the cut-out portion 122 of the front face sheet 124. As one example, the front face sheet 124 may be made of acrylic.

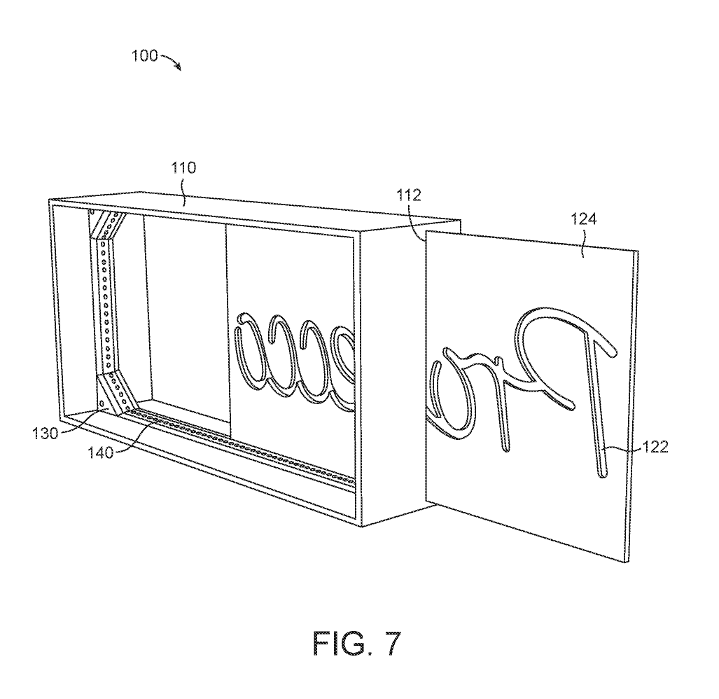

As noted above, the front face 120 of the front face sheet 124 is mirrored in the present embodiment. With reference to FIG. 7, the rear face of the front face sheet 124 may also be provided with a mirrored finish, so that light generated within the lightbox will be reflected backwards if it is not emitted forwards through the transparent or translucent portion 122.

Referring again to FIG. 2, it can be seen that the lightbox 100 of the present embodiment includes an outer frame 110 as well as an inner frame 130 located peripherally within the outer frame 110.

A light source 140 in the form of LED strips is provided on the inner surface of the inner frame 130, so as to illuminate an internal box portion of the light box 100 which is formed within the inner frame 130 and between the front face sheet 124 and a rear dispersion sheet 150 mounted to the back of the inner frame 130.

By virtue of this construction, the box portion defined by the front face sheet 124, the rear dispersion sheet 150 and the inner frame 130 defines an open, empty space devoid of obstruction, allowing the front 120 and back 152 faces of the lightbox to be illuminated substantially evenly. By arranging the LED strips 140 to shine inwardly towards the centre of the empty space, no portion of the front or back face is directly illuminated with high intensity light, thereby avoiding hot spots and providing a substantially uniform distribution of light across the front and back faces 120, 152. Furthermore, as no part, component or other object extends into or through the box portion, the light distribution is unimpeded by any obstruction within the box portion, so that shadows are not cast onto the front and back faces 120, 152.

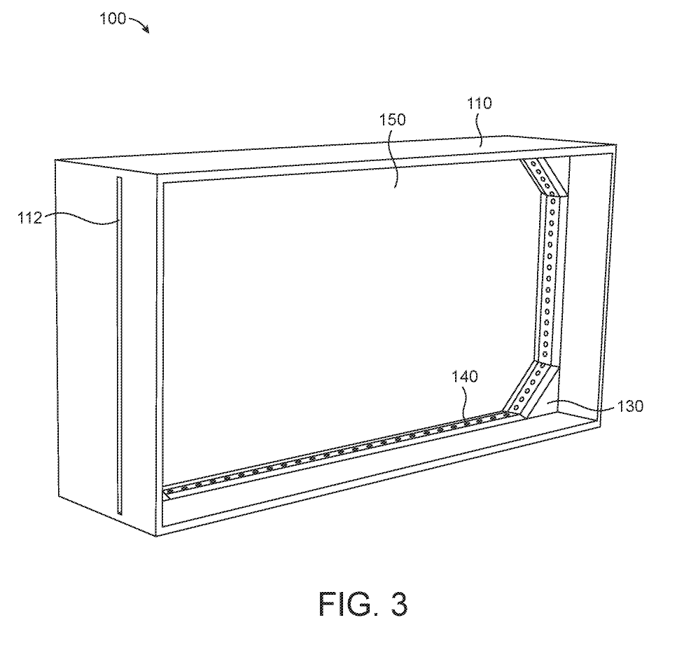

To improve the evenness of the light distribution across the front and back faces 120, 152 of the lightbox 100, light diffusion or dispersion sheets may be provided to the front and rear of the inner frame 130, as illustrated by the rear dispersion sheet 150 shown in FIGS. 2 and 3. Although not shown, a similar dispersion sheet is preferably provided to the front of the inner frame 130, and lies behind the front face sheet 124, so as to provide more uniform light distribution and illumination across the front face 120 of the lightbox 100, in order to more evenly illuminate the translucent or transparent portion 122 of the front face 120.

FIG. 3 shows the lightbox 100 with the front face sheet 124 entirely removed, with the front dispersion sheet also not shown, so that the disposition of the inner frame 130 within the outer frame 110 can be clearly seen. As shown, the inner frame 130 is recessed from the front edge of the outer frame 110.

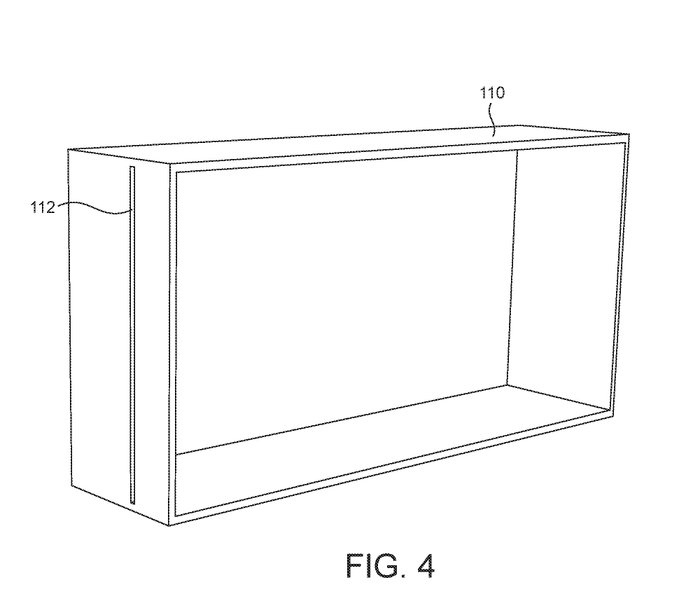

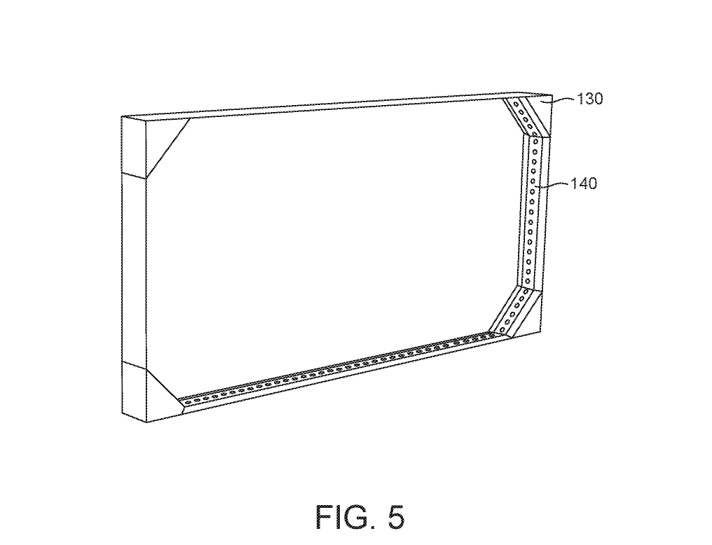

In FIG. 4, the outer frame 110 is shown in isolation, whilst the inner frame 130 is shown in FIG. 5, together with the LED light strips forming the light source 140, without the outer frame 110.

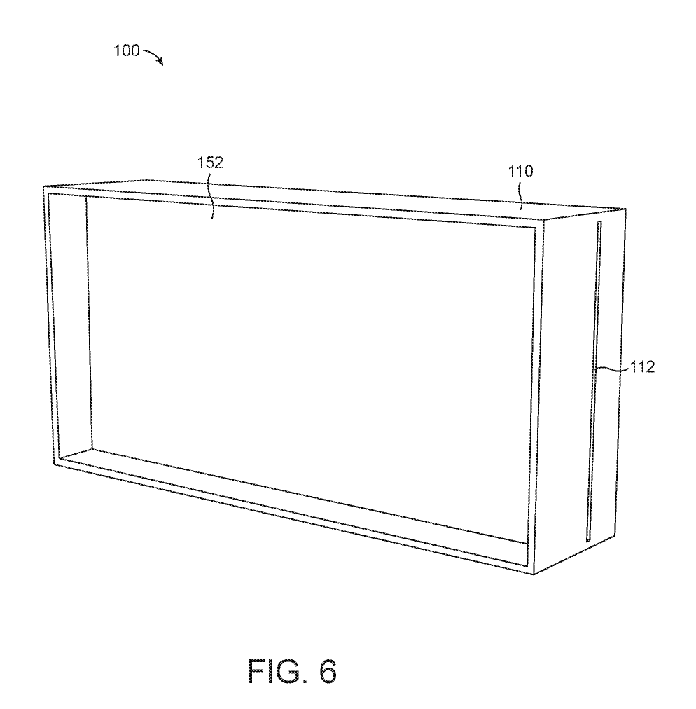

FIG. 6 shows a rear perspective view of the light box 100, in which the back face 152 is shown. Back face 152 is provided by the backward facing surface of the rear dispersion sheet 150, as visible in FIGS. 2 and 3. It can be seen that the back face 152 of the lightbox 100 is also recessed inwardly from the back edge of the frame 110, in a similar way to the front face 120.

The dispersion or diffusion sheets such as sheet 150 provided at the front and rear of the inner frame 130 may be the same as or different from one another. Suitable materials for the diffusion or dispersion sheets are coloured translucent PVC materials that may be provided with surface texturing and/or may include glitter specks or other reflective particles dispersed therein. Another alternative material for the dispersion or diffusion sheets is translucent PMMA. These materials can have a diffusion and/or scattering effect on the light, thereby providing a more uniform lighting intensity across the front and back faces of the lightbox.

The illumination provided by the lightbox 100 may be coloured. The colour of the light emitted by the light box from the front and back faces 120, 152 may be determined by the colour of the LED lighting strips 140 or other light source within the lightbox 100, and/or by the colour of the dispersion or diffusion materials provided to the front and back of the inner frame 130.

Furthermore, the LED strips 140 of this or any other embodiment may include colour change LEDs, so that the colour of the light emitted from the lightbox 100 may change upon command or may change over time following a pre-set cycle.

In the present embodiment, as well as in each of the illustrated embodiments of the present application, the LED light strips 140 are arranged so that the same LEDs illuminate both the front face 120 and the back face 152 of the lightbox 100, resulting in an economical structure to manufacture, and requiring minimal power consumption for illuminating both front and back faces of the lightbox 100.

In alternative embodiments of the present invention, different light sources may be provided for illuminating the front face and the back face of the lightbox. In either case, the colour of the light emitted from the back face of the lightbox may be different from the colour of the light emitted from the front face of the lightbox dependent, inter alia, upon the colour of the light source illuminating each face and the colour of any dispersion or diffusion sheets or colour filters provided at the front face and/or back face, as noted above.

In the embodiment of FIGS. 1 to 7, the outer frame 110 is formed from transparent acrylic sheets which have been assembled together to form a rectangular cross-section frame, i.e., a frame delimiting rectangular front and back faces 120, 152. The rectangular frame 110 has sufficient depth so that it can stand stably in order to present the front and back faces 120, 152 of the light box 100 in a substantially vertical orientation, substantially aligned with and parallel to one another. The outer frame 110 essentially defines the size and shape of the lightbox 100, and in this example has a width of 250 mm, a height of 125 mm and a depth of 60 mm.

The rectangular cross-sectional shape of the outer frame 110 allows the orientation of the lightbox 100 to be freely altered, and it may be arranged to stand on one of the shorter side edges, instead of on one of the longer side edges of the frame 110 as depicted in FIGS. 1 to 7. This allows the orientation of the lightbox to be altered, as may be desirable according to the specific orientation of the graphic, i.e., the letter(s), word(s), symbol(s) or other image to be illuminated on the front face 120.

As for the inner frame 130, the triangular corner pieces shown in FIGS. 2, 3, 5 and 7 may be provided as acrylic blocks which are to be fixed within the outer frame 110 and provide structural rigidity to the outer frame 110, as well as a fixing point for attaching the back face sheet 150 and the front dispersion sheet to the back and front, respectively, of the inner frame 130. The inner frame 130, as shown in FIG. 5, may otherwise be constituted by mirrored strips, on which the LED strips forming the light source 140 are mounted. In an alternative arrangement, the light source 140 may be accommodated within the inner frame 130 and/or outer frame 110, instead of being mounted on the inner surface of the inner frame 130.

The outer frame 110 as shown in FIG. 4 of the present application is, in the embodiment of FIGS. 1 to 7, provided in the form of clear acrylic sheets which are bonded together at the corner edges and which are substantially or fully transparent. The outward facing surfaces of the inner frame 130, as shown in FIG. 5, are accordingly preferably provided with a mirror finish, such that the inner frame presents as a silvered or mirrored box fitted within the transparent acrylic outer frame 110.

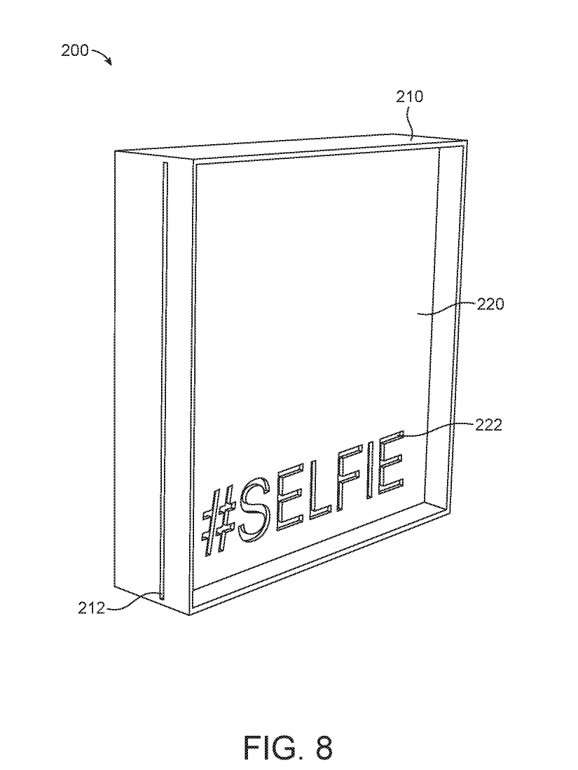

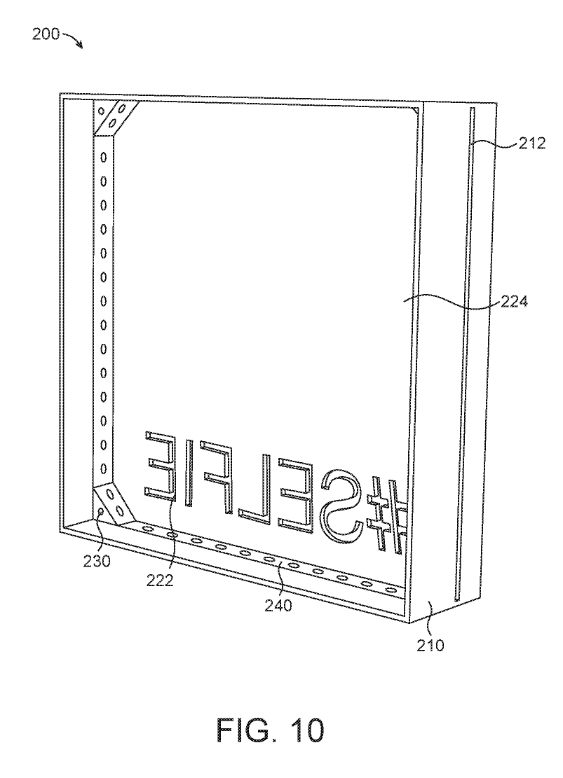

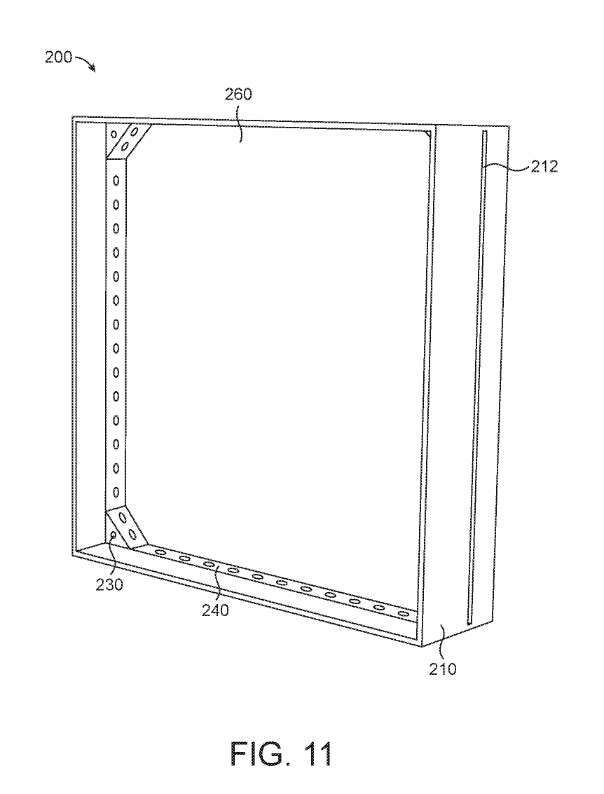

A second embodiment of a lightbox 200 according to the present invention is shown in FIGS. 8 to 11.

The constructional details of the lightbox 200 are substantially the same as for the lightbox 100 of FIGS. 1 to 7, but the lightbox 200 has different width and height dimensions. The lightbox 200 in this example has a width of 250 mm, a height of 250 mm and a depth of 60 mm.

The lightbox 200 has a front face 220 which is substantially opaque and provided with a mirror finish, in the same way as the front face 120 of the lightbox 100 of FIGS. 1 to 7. The front face sheet 224 may again also have a mirrored rearward-facing surface. The front face 220 also includes a substantially transparent or translucent portion 222, which is again provided by forming a cut-out in a front face sheet 224, for example by laser cutting an acrylic sheet. The front face sheet 224 may similarly be slidably removable from the frame 210 of the lightbox 200 via the vertical side slot 212, in similar manner as for the lightbox 100 of FIGS. 1 to 7.

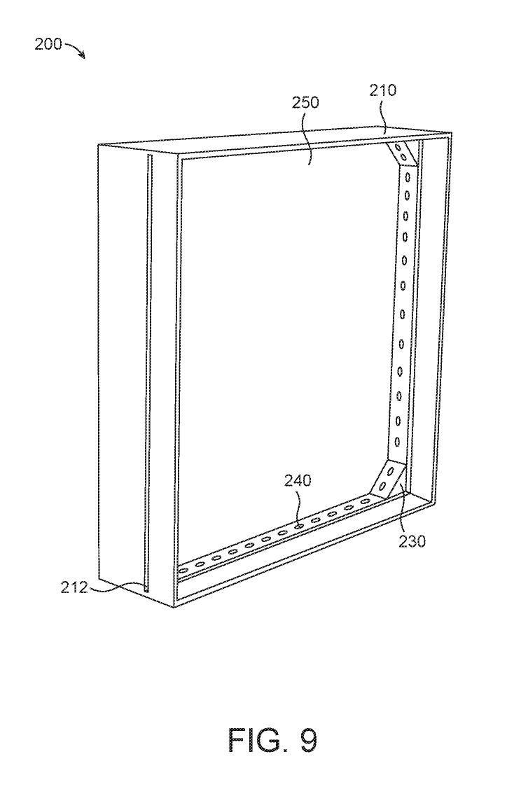

Turning to FIG. 9, the lightbox 200 has a similar structure to the lightbox 100, with an inner frame 230 mounted within outer frame 210, and having LED lighting strips providing a lighting source 240 mounted to the inner side of the inner frame 230. A diffusion or dispersion sheet 250 is mounted to the back of the inner frame 230 and forms the back face of the lightbox 200 similar to back face 152 shown in FIG. 6 for the lightbox 100.

As can be appreciated from FIGS. 8 to 11, the front face and the back face of the lightbox 200 are recessed relative to the front and back edges of the frame 210, in the same manner as for the lightbox 100. The constructional details of the lightbox 200 of FIGS. 8 to 11 are otherwise the same as for the lightbox 100 of FIGS. 1 to 7, including the provision of a light dispersion or diffusion sheet on the front side of the inner frame 230 (not shown) so as to lie behind the front face sheet 224.

In the second embodiment of FIGS. 8 to 11, the front face 220 is provided as a substantially opaque mirrored surface, to enable a user to take a photograph of themselves in the mirror (such a self-taken photograph being known colloquially as a “SELFIE”), as implied by the word formed by the transparent or translucent cut-out portion 222.

Although not shown, in a preferred embodiment of the lightbox 200, the lightbox may also be provided with a pen holder and a pen to be used for writing on the front face 220. The front face 220 is therefore in this embodiment provided as a wipe-clean acrylic surface, from which the ink of the pen may be removed by wiping with a cloth after writing on the surface. A user may in this way write or draw on the mirrored surface 220 prior to taking a “SELFIE” photograph of the image in the mirror. When not being used, the pen can be safely stored in the pen holder. Any other embodiment may also be provided with a pen and pen holder and/or such a wipe-clean front face.

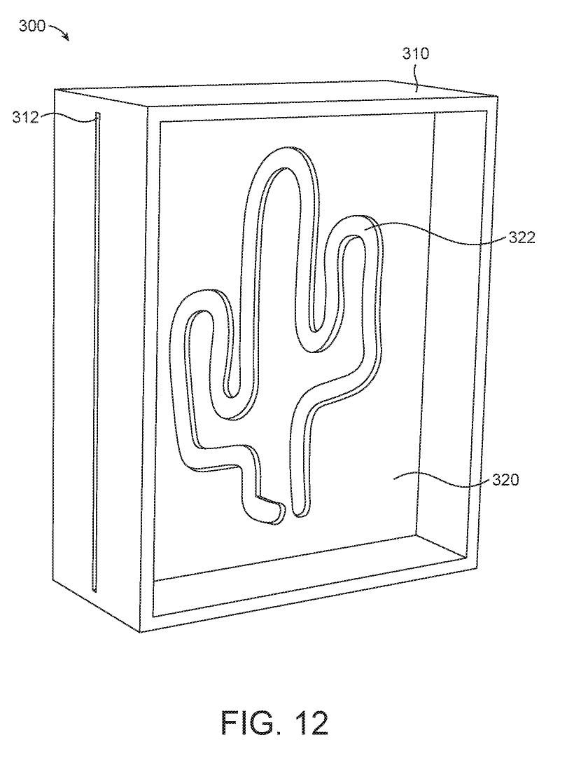

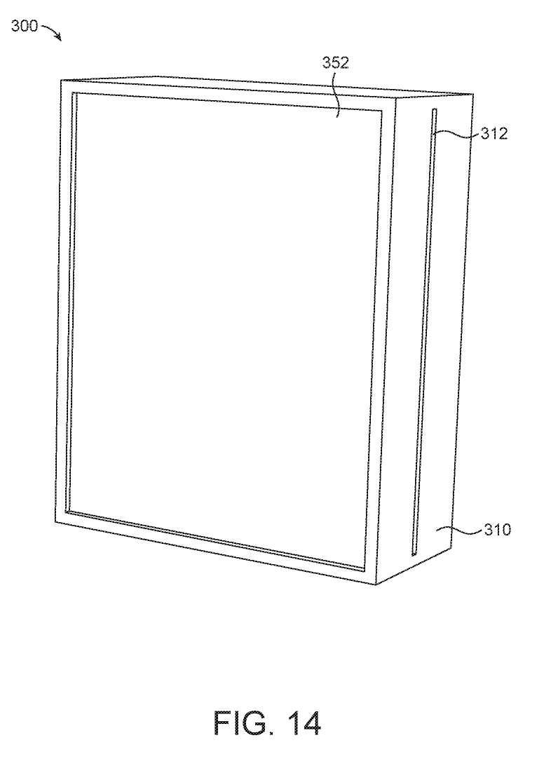

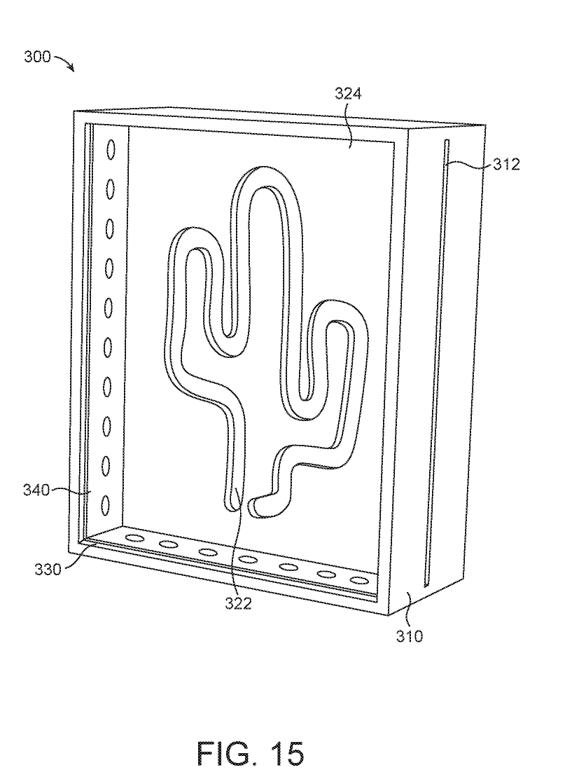

A third embodiment of the present invention is now described with reference to FIGS. 12 to 15, showing a lightbox 300. The lightbox 300 has a similar construction to the lightboxes 100 and 200 of the first and second embodiments of the present invention, except that the frame 310 has a reduced depth, so that the back face 352 is less deeply recessed, as shown in FIG. 14. In this embodiment, the lightbox 300 has a width of 90 mm, a height of 110 mm and a depth of 40 mm.

Otherwise, the lightbox 300 is similarly constructed and includes an outer frame 310, with a front face 320 provided on a front face sheet 324 which can be slidably removed through a horizontal slot 312 in one side of the frame 310. The front face 320 is substantially opaque and provided with a mirrored finish, except for a transparent or translucent portion 322, which is again provided in this embodiment as a laser cut-out portion.

As shown in FIG. 12, the front face 320 is recessed back from the front edge of the outer frame 310.

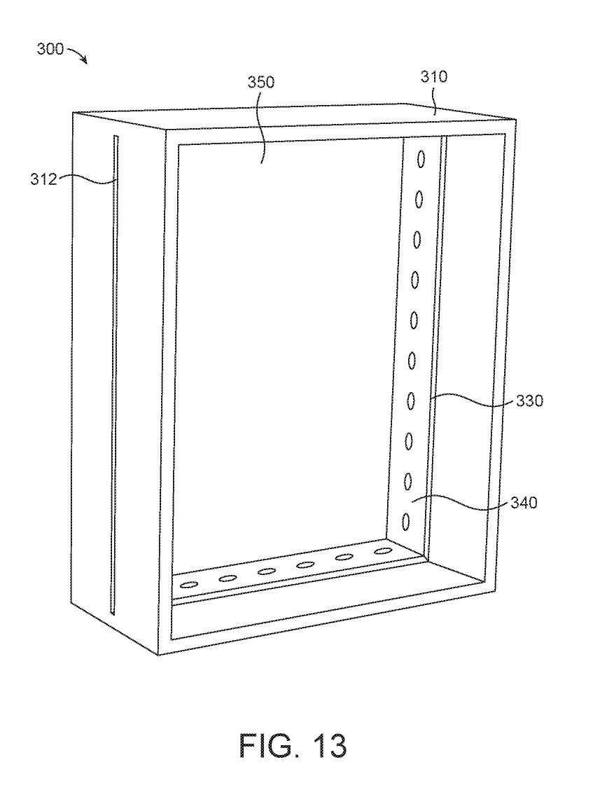

With reference to FIG. 13, it can be seen that the lightbox 300 again includes an outer frame 310 and an inner frame 330. Triangular corner pieces as shown in the first and second embodiments 100, 200, may not be required for structural stability of the outer frame 310, but may be provided if desired as they provide a convenient anchoring point for attaching front and rear dispersion or diffusion sheets to the front and back of the inner frame 330. LED strips or other light sources 340 are provided on the inner surface of the inner frame 330. If desirable, the inner frame 330 may be dispensed with and the LED light strips or other light source 340 may simply be attached to the inside of outer frame 310.

As noted above, the inner frame 330 is provided with a smaller recess from the rear of the outer frame 310, and as such the vertical slot 312 for removing the front face sheet 324 is relatively further back in the outer frame 310 as compared with the first and second embodiments 100, 200. As such, the inner frame 330 comes nearly to the back of the outer frame 310 and is provided with no recess or with only a small recess.

As the width and height dimensions of the outer frame 310 are smaller than those of the lightboxes 100, 200 of the first and second embodiments, the outer frame 310 does not need to be as deep in order to stand stably on either of the long or short side edges of the frame 310, in order to present the front and back faces 320, 352 vertically. Back face 352 of the rear dispersion sheet 350 is nevertheless preferably slightly recessed from the back edge of the outer frame 310, in order to protect it from accidental loading or impact.

In all of the foregoing described embodiments, the lightboxes are provided with rectangular frames allowing the lightbox to stand on either the long or short side edges of the outer frame 110, 210, 310 in order to present the front and back faces vertically. In all of these embodiments, the front face sheet 124, 224, 324 is removable and interchangeable so that different graphics such as different letters, words, messages, symbols or other images can be displayed on the front faces 120, 220, 320 of the lightboxes 100, 200, 300 by exchanging the front face sheet 124, 224, 324. The lightboxes may be provided with a set of interchangeable front face sheets bearing different such graphics, or separate front face sheets may be purchased individually or in packs. The present invention also contemplates a method according to which customised, bespoke front face sheets may be ordered, individually or in packs, in order to provide unique graphics on the lightbox. Bespoke back face sheets may also be provided in a similar way.

Preferably, grooves are provided in the side walls of the outer frame 110, aligned with the extreme edges of the slots 112, 212, 312, along which the front face sheets 124, 224. 324 are able to slide in and out of the outer frames 110, 210, 310. The grooves serve to hold or retain the front face sheets securely in place when the lightbox is in use.

As an alternative to providing the slots 112, 212, 312 in the outer frames 110, 210, 310 for exchanging the front face sheets 124, 224, 324, the front face sheets could be provided with magnetic or other releasable attaching means, for attaching the front face sheets to the front of the lightbox.

In all of the illustrated examples of FIGS. 1 to 15, the back face of the lightbox is provided as a transparent or translucent dispersion or diffusion sheet so that light will be emitted backwards out of the back face of the lightbox when the light source is turned on to illuminates the front and back faces. The light emitted from the back face of the lightbox will illuminate an area or volume to the rear of the lightbox, and may be used to produce a back-lit effect, for example, on a nearby wall. The back-lit effect presents a decorative, ambient lighting effect which has visual impact in combination with illumination of the front face and the graphic presented thereon.

Whilst the lightbox embodiments 100, 200 are essentially stand-alone items, the embodiment of the light box 300 of FIGS. 12 to 15 is of a smaller size and scale and several such smaller lightboxes may be grouped together. For example, a number of such smaller lightboxes 300 may be provided with front faces 320 each exhibiting an individual alphanumeric character. The lightboxes 300 may then be arranged side-by-side to spell out a word, acronym or message. In such an arrangement, the lightboxes 300 may have different colour illumination, and so may provide an interesting colour palette to the back-lit wall or similar area.

Equally, various different lighting effects may be realised with the lightboxes of the present invention, including but not limited to: the light sources changing colour; the light sources varying in brightness or intensity; the light sources flashing; the light sources fading in and out; and combinations of these.

When a group of lightboxes such as the lightbox 300 is provided, these lightboxes may be configured to be inter-connectable. For example, the lightboxes may be directly connected to one another, such as via a Bluetooth™ connection or via interlinking cables. Alternatively, the lightboxes may be indirectly connected to one another such as by being connected to a common network such as a WiFi network. The lightboxes may then be configured to operate in cooperation with one another so as to perform synchronized or coordinated lighting effects, such as coordinated flashing, colour changing or fading in and out, or combinations of these.

Furthermore, it is envisaged that any of the lightboxes of the present invention may be connectable to a remote device, so as to be controllable by such remote device. In one example, the remote device may be a computer, laptop, tablet computing device, or mobile phone such as a smart phone running a software application, which may be used to control the lighting effect of the lightbox, such as turning the light source on and off and performing any of the above-noted lighting effects. Such a software application may also be used to coordinate the lighting effects between multiple lightboxes, as applicable.

Similarly, the lightboxes may be connectable directly or indirectly to a music playing device (which may also be a computer, laptop, tablet computing device or mobile phone such as a smartphone), in order to perform lighting effects matching the mood and/or tempo of the music so that the lighting provided by the lightbox or lightboxes is dependent upon the piece of music being played by the music player.

The lightboxes of the present invention may also be controlled via a remote control, of conventional hand-held type, or otherwise by buttons provided directly on the lightbox or on a power pack or controller of the lightbox connected to the lightbox via a cable.

In this connection, it is noted that the illustrated embodiments of the lightboxes 100, 200, 300 shown in FIGS. 1 to 15 do not indicate the location of the power source for powering the light sources 140, 240, 340. The light sources 140, 240, 340 may be powered, for example, by a battery pack mounted within the frame of the lightbox, although this may obscure the uniform intensity of transmission and/or emission of light from the front and/or back faces of the lightbox.

It is therefore anticipated to provide a battery pack, such as a conventional battery pack holding two or more AA or AAA batteries, and connected to the lightbox via a suitable length of cable. Such a battery pack can adequately power LED light strips for a substantial period of time before the batteries run out of charge. Alternatively, the lightboxes may be configured to be mains powered, and to have a cable and a plug for connecting to a domestic or commercial power socket.

Nevertheless, it is anticipated that the most preferred arrangement would be to have a battery pack connected to the lightbox by a suitable length of cable, thus enabling the battery pack to be kept out of sight and to maintain a neat and minimalist finish to the frame of the lightbox 100, 200, 300. An on/off switch and/or other controller may be incorporated into the battery pack and/or provided on the same cable.

Although, as noted above, the rectangular cross-section of the lightboxes 100, 200, 300 is easy to construct from sheets of transparent acrylic, and allows the lightbox to stand up in different orientations, many different cross-sectional shapes of such a lightbox are possible. For example, for a romantic design the lightbox may have a heart-shaped cross-section, whilst further shapes may be preferred depending upon the graphic to be illuminated on the front face. For example, a circular cross-section frame might be desirable if the graphic to be represented on the front face is an emoji or other emoticon. In other cases an oval shape may be preferred. Many other design possibilities may be realised, with the appreciation that having the light sources mounted within the frame or on the inside surface of the frame, and keeping the central space of the lightbox empty, allows the entire internal volume of the lightbox to be illuminated, thereby providing a more even and uniform light distribution across the front and back faces of the lightbox.

In further alternative embodiments of the present invention, it may be desirable to provide a lightbox having illuminated front and back faces but without providing an ambient back-lit effect. It may instead be preferred to have alternative messages or graphics displayed on the front and back faces of the lightbox. In such cases, a back face sheet may also be provided which is substantially opaque and has a transparent or translucent portion displaying a graphic that is different from the graphic displayed on the front face. In this way, the lightbox may be reversible, so as to display the desired graphic depending upon circumstances. As one example, the front face could be illuminated green and display the transparent or translucent word “open”, whilst the back face could be illuminated red and display the transparent or translucent word “closed”. Many other variations are possible.

In all of the foregoing examples, it is not essential for the front face sheet and/or the back face sheet to be interchangeable, and the lightbox may be made with a single front and/or back face sheet bearing a single unchanging graphic.

1-39. (canceled)

40. A lightbox, comprising:
a front face that faces forward;
a back face that faces backwards; and
one or more light sources disposed within the lightbox,
wherein the one or more light sources are arranged to illuminate the front face and the back face.

41. The lightbox of claim 40, wherein at least a portion of the front face is translucent or transparent or cut out, wherein the portion of the front face is in a shape of a letter, word, message, image or symbol, wherein a remainder of the front face is opaque or substantially opaque.

42. The lightbox of claim 41, wherein the portion comprises a cut out from a sheet that is opaque or substantially opaque, wherein the sheet is mirrored on a side facing forward.

43. The lightbox of claim 40, wherein at least a portion of the back face is translucent or transparent, wherein the lightbox is arranged to emit light backwards from the back face to illuminate an area or volume behind the back face.

44. The lightbox of claim 40, wherein the front face and the back face are a same shape and size, wherein the front face and the back face are arranged parallel to each other, wherein the front face and the back face are aligned opposite one another.

45. The lightbox of claim 40, further comprising:
a frame,
wherein the front face, the back face, and the frame are arranged to form a box, wherein the one or more light sources are disposed in the box, wherein the one or more light sources are disposed within the frame or on an inside surface of the frame such that a central space is substantially empty, wherein the central space is within the frame and between the front face and the back face.

46. The lightbox of claim 45, wherein the frame comprises:
an inner frame disposed within an outer frame,
wherein the front face and the back face are mounted on or adjacent to a front and a back, respectively, of the inner frame, wherein the front face and the back face are recessed backwards and forwards, respectively, within the outer frame.

47. The lightbox of claim 40, wherein the one or more light sources are one or more light emitting device strips.

48. The lightbox of claim 43, wherein the back face comprises a sheet that diffuses or disperses light to distribute light from the one or more light sources by which the sheet is illuminated.

49. The lightbox of claim 41, further comprising a sheet that diffuses or disperses light behind the front face to distribute light from the one or more light sources by which it is illuminated.

50. The lightbox of claim 40, wherein the front face and the back face emit light of the same color or different colors when illuminated color.

51. The lightbox of claim 40, wherein the one or more light sources are configured to produce one or more lighting effects selected from a group of lighting effects consisting of change color, vary in brightness or intensity, flash, and fade in and out.

52. The lightbox of claim 40, wherein the lightbox is configured to communicate directly with another device or to communicate with one or more other devices wirelessly or via a network.

53. The lightbox of claim 40, wherein the lightbox is configured to communicate with another lightbox, wherein the lightbox and the another lightbox are configured to operate in synchronization with one another to produce a desired lighting pattern or effect, or to operate under command of a common controller, and/or wherein the lightbox is configured to communicate with a music player and the lightbox is configured to illuminate the front face and/or the back face in conjunction with music being played on the music player.

54. The lightbox of claim 40, either wherein the one or more light sources are powered by an external power source connected to the lightbox by wires or a cable, and wherein the external power source includes a battery pack and/or a plug connectable to a commercial or domestic power supply, or wherein the one or more light sources are powered by an internal power source such as a battery pack integrated into the lightbox.

55. The lightbox of claim 40, wherein the front face is provided on a sheet that is mirrored on a side opposite the front face.

56. The lightbox of claim 40, wherein the front face is disposed on a sheet adapted to be inserted into a slot in a top or a side of the lightbox to position the sheet in front of the one or more light sources, or wherein the front face is disposed on a sheet adapted to be attached to the front of the lightbox by magnetic or other releasable attachment to position the sheet in front of the one or more light sources.

57. The lightbox of claim 56, further comprising a plurality of front face sheets that are interchangeable, the sheets bearing different letters, words, messages, images and/or symbols to be illuminated by the one or more light sources.

58. The lightbox of claim 40, wherein the front face comprises a wipe-clean surface to permit the front face to be written on and then for the writing to be wiped off, wherein the lightbox further comprises a pen holder and a non-permanent-ink pen releasably securable in the penholder for writing on the wipe-clean surface.

59. The lightbox of claim 40, wherein the front face comprises a first letter, word, message, image and/or symbol to be illuminated by the one or more light sources, wherein the back face comprises a second, different letter, word, message, image and/or symbol, or a different combination thereof, to be illuminated by the one or more light sources.
